(19) United States
(12) Patent Application Publication
(10) Pub. No.: US 2025/0155643 A1
(43) Pub. Date: May 15, 2025

(54) ALTERNATING FILTER STACK ASSEMBLY FOR MULTIPLEXER AND DEMULTIPLEXER APPLICATIONS

(71) Applicant: Cisco Technology, Inc., San Jose, CA (US)

(72) Inventor: Iman HASSANI NIA, Carlsbad, CA (US)

(21) Appl. No.: 18/510,576

(22) Filed: Nov. 15, 2023

(51) Int. Cl. G02B 6/293

(52) U.S. Cl. CPC G02B 6/29362; G02B 6/2938

(57) ABSTRACT

A multiplexer and demultiplexer (MDM) is disclosed. In one aspect, an MDM includes a plurality of filters arranged along a propagation direction. Each one of the filters has a thin-film filter (TFF) supported by a substrate. The filters are arranged so that each filter induces an opposite warpage of an optical signal traversing along the propagation direction than an immediately preceding filter.

### TECHNICAL FIELD

Embodiments presented in this disclosure generally relate to wavelength division multiplexing systems. More specifically, embodiments disclosed herein relate to multiplexer and demultiplexer optical devices.

### BACKGROUND

Wavelength division multiplexing (WDM) systems increase channel capacity by utilizing a broad range of light spectrum to multiplex multiple data channels with different wavelengths. An optical multiplexer and demultiplexer (MDM) can be used to realize a WDM system. Generally, an MDM is a free-space, millimeter-scale optical device that includes separate glass substrates coated with thin-film filters (TFFs). For demultiplexing, the reflectivity of such TFFs allows for spatial separation of a collimated beam according to wavelength. Conversely, multiplexing can be achieved if the direction of the light is reversed.

One challenge with MDMs is that the intrinsic stress of the TFFs can induce warpage. Warpage can significantly affect the optical efficiency of an MDM. Conventional MDMs typically have filters that induce similar warpage stacked side-by-side along a light propagation direction. Consequently, a beam traversing through such an MDM accumulates angular errors as it reflects from one filter to the next. The accumulated angular errors can result in substantial beam misalignment on grating couplers of a photonic die. The warpage-induced angular and positional errors can limit the range of the MDM and can produce less than desirable optical coupling performance.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A and 1B are schematic diagrams of a Wavelength Division Multiplexing (WDM) system in accordance with an example embodiment of the disclosure.

FIG. 2 is a schematic side view of a multiplexer and demultiplexer (MDM) with thin-film filters (TFFs) in accordance with an example embodiment of the disclosure.

FIG. 3A is a schematic top view of the TFFs of the MDM of FIG. 2 and depicts two optical signals traversing from one TFF to the next.

FIG. 3B depicts a series of schematic front views showing the optical signals of FIG. 3A reflecting off of the various TFFs.

FIG. 4 is a schematic side view of an MDM with an alternating filter stack in accordance with another example embodiment of the disclosure.

FIG. 5 is a schematic side view of an MDM with an alternating filter stack in accordance with yet another example embodiment of the disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a multiplexer and demultiplexer (MDM). The MDM includes a plurality of filters arranged along a propagation direction, each one of the plurality of filters has a thin-film filter (TFF) supported by a substrate. The plurality of filters are arranged so that each filter of the plurality of filters induces an opposite warpage of an optical signal traversing along the propagation direction than an immediately preceding filter of the plurality of filters.

Another embodiment presented in this disclosure is a multiplexer and demultiplexer (MDM). The MDM includes a plurality of filters arranged along a propagation direction, each one of the plurality of filters has a thin-film filter (TFF) supported by a substrate. The plurality of filters are arranged so that the TFFs have alternating concave and convex curvatures along the propagation direction.

Yet another embodiment presented in this disclosure is a multiplexer and demultiplexer (MDM). The MDM includes a filter block and a plurality of filters arranged along a propagation direction in a first stack and a second stack spaced from the first stack by the filter block. Each one of the plurality of filters has a thin-film filter (TFF) supported by a substrate. An optical signal traversing along the propagation direction traverses between the first stack and the second stack in an alternating manner. The plurality of filters are arranged so that a second filter of the plurality of filters arranged in the second stack induces an opposite warpage of an optical signal traversing along the propagation direction than a first filter of the plurality of filters arranged in the first stack.

### Example Embodiments

Warpage is one of the main drivers of loss for highly dense and large bandwidth multichannel MDMs. Warpage-induced angular and positional errors can limit the range of such an MDM and can produce less than desirable optical coupling performance. Various embodiments of MDMs that address such challenges are provided herein. More specifically, various embodiments of MDMs that are arranged to mitigate warpage are disclosed.

In one example aspect, an MDM includes a plurality of filters arranged along a propagation direction. Each one of the filters has a thin-film filter (TFF) supported by a substrate. In one embodiment, the filters are arranged so that each filter induces an opposite warpage of an optical signal traversing along the propagation direction than an immediately preceding filter. Accordingly, the angle error of reflection of a given filter becomes neutralized by its next nearest neighbor filter. Thus, effectively, the warpage induced by one filter can be immediately corrected by the next filter. As a result, the progressive increase of angle errors found in conventional MDMs is prevented or mitigated.

In some embodiments, to achieve self-correcting warpage, the filters of an MDM can be arranged in an “alternating” filter stack so that an optical signal is incident to alternating concave and convex TFFs. In some embodiments, the TFFs of the alternating filter stack can have opposite radius of curvature from one filter to the next, or rather, each TFF can have a same length radius but alternate in sign from one filter to the next (e.g., convex to concave, or vice versa). In other embodiments, the TFFs of the alternating filter stack can alternate in radius of curvature sign (e.g., convex to concave, or vice versa), but the TFFs can have a different length radius of curvature from one filter to the next. Also, the TFFs can be vertically offset from one another, or can be vertically aligned despite having opposite curvature. In addition, the filters can be arranged in a single-stack arrangement or a multi- or split-stack arrangement. MDMs having an alternating filter stack arrangement as disclosed herein can be operated in a demultiplexing mode, a multiplexing mode, or both, including both modes simultaneously.

The MDMs of the present disclosure can provide certain advantages, benefits, and/or technical effects. For instance, angular and positional errors can be eliminated or mitigated, which consequently results in improved optical performance of an MDM, such as improved coupling loss. Moreover, because such errors are eliminated or mitigated, the TFFs of an MDM can accommodate more channels (or more parallel optical signals) than conventional MDMs. Also, in some aspects, despite the TFFs of the filters having alternating concave and convex curvature, the TFFs can be aligned vertically, which allows for uniform pitch to be produced by spectral beams passing through the TFFs, which in turn allows for uniform spacing of grating couplers on a photonic die of the MDM.

Further, for MDMs of the present disclosure having an alternating split-stack arrangement, the longitudinal length of such MDMs can be made shorter compared to conventional MDMs, namely because an MDM having an alternating split-stack arrangement can have filters stacked in separate stacks that can be organized in a staggered manner rather than the filters being arranged in a side-by-side manner. Thus, such an MDM is particular useful for miniaturized or compact systems. Further, such split-stack arrangement MDMs can allow for spectral beams to produce a uniform pitch and allows for the filters to be stacked in a same orientation, e.g., right side up, which can simplify fabrication of such an MDM.

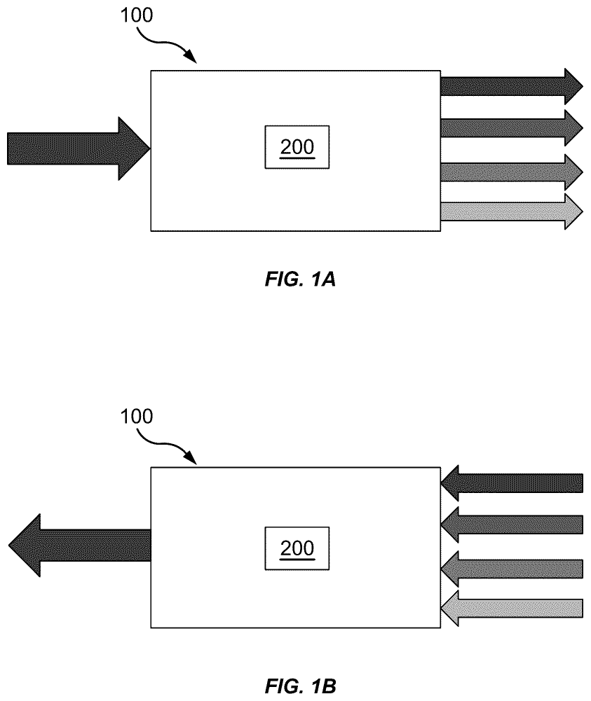

With reference now to the drawings, FIGS. 1A and 1B are schematic diagrams of a Wavelength Division Multiplexing (WDM) system, or WDM system 100, in accordance with example embodiments of the present disclosure. The WDM system 100 is operable to split (de-multiplex) or combine (multiplex) beams based on wavelength. For instance, in FIG. 1A, the WDM system 100 is shown splitting or demultiplexing a beam by wavelength. In FIG. 1B, the WDM system 100 is depicted combining or multiplexing beams of different wavelength bands into a single beam. To facilitate demultiplexing or multiplexing, the WDM system 100 can include a multiplexer and demultiplexer (MDM), or MDM 200. In accordance with inventive aspects of the present disclosure, the MDM 200 includes an alternating filter stack that advantageously mitigates adverse warpage effects found in conventional MDM systems. The MDM 200 will be further described below.

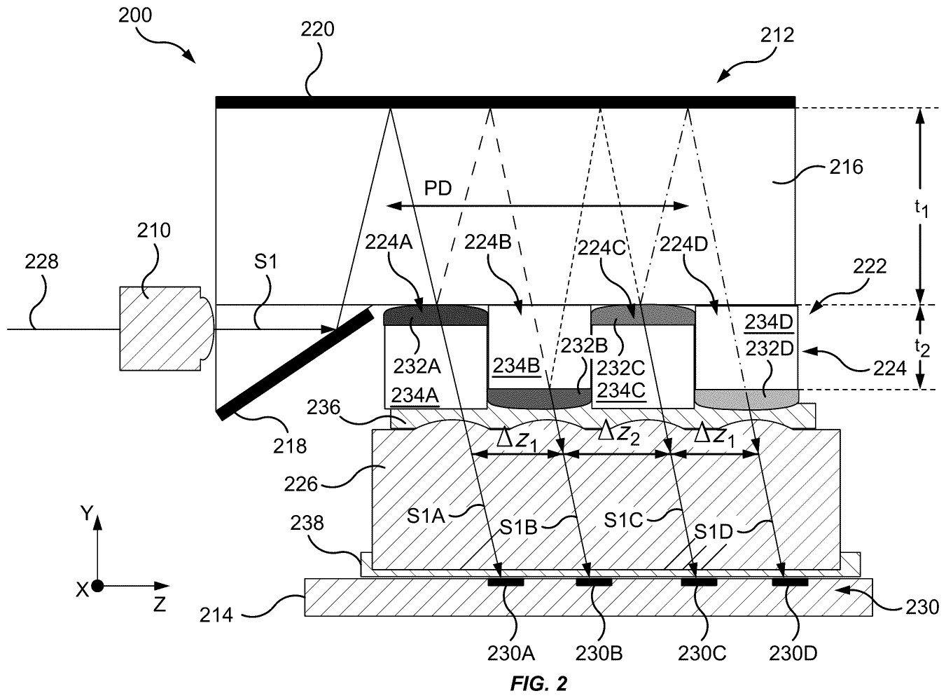

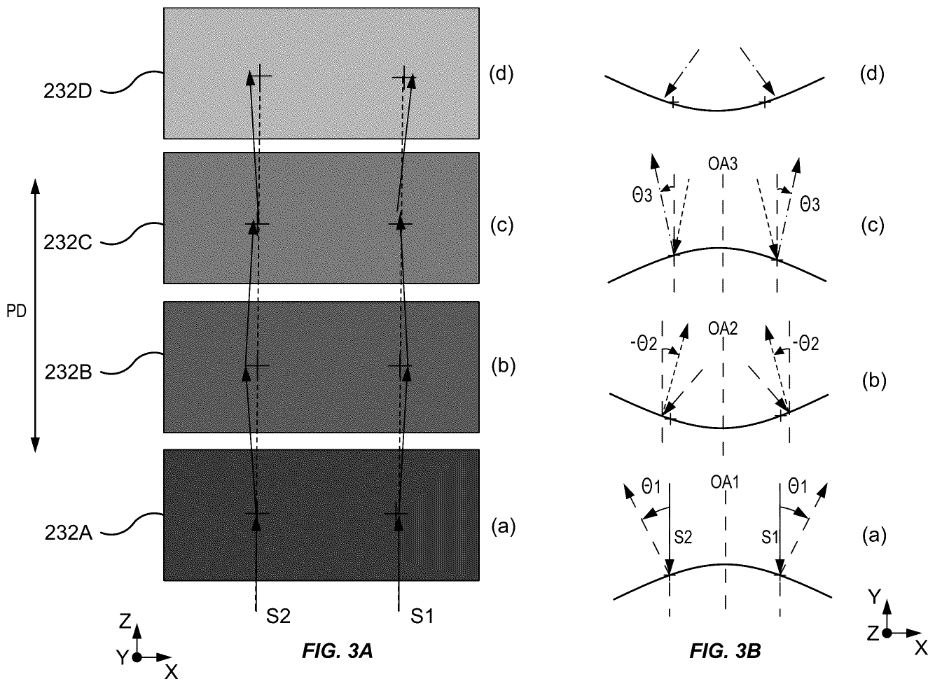

FIG. 2 is a schematic side view of the MDM 200 in accordance with an example embodiment of the disclosure. For reference, the MDM 200 defines a longitudinal direction Z, a lateral direction X (going into and out of the page in FIG. 2; see also FIGS. 3A and 3B), and a vertical direction Y. The longitudinal direction Z, the lateral direction X, and the vertical direction Y are mutually perpendicular to one another and form an orthogonal direction system. In FIG. 2, a demultiplexing mode is depicted, but the MDM 200 is also operable in a multiplexing mode. For a multiplexing mode, the input/outputs and beam directions shown in FIG. 2 are reversed. The MDM 200 can be operated solely in the demultiplexing mode, solely in the multiplexing mode, or simultaneously in the demultiplexing and multiplexing modes.

As illustrated in FIG. 2, the MDM 200 includes a lens 210, a coupler 212, and a photonic die 214. The coupler 212 includes a filter block 216, a prism 218, a mirror 220, a filter stack 222 having a plurality of filters 224, and a lens array 226. The coupler 212 functions to direct light from the lens 210 to the photonic die 214 and/or vice versa, depending on the direction of light propagation.

The lens 210 can be an input lens in the demultiplexing mode shown in FIG. 2, but can also function as an output lens in a multiplexing mode. The lens 210 can be coupled with one or more optical fibers 228. In the demultiplexing mode, an optical signal S1 (e.g., a broadband beam) from the one or more optical fibers 228 can be collimated by the lens 210 and directed into the filter block 216, which can be formed of glass or a like material. The optical signal S1 can traverse through the filter block 216 and can be directed to the mirror 220 by the prism 218. In the demultiplexing mode, the optical signal S1 is incident on each filter 224 of the filter stack 222. At each incidence, a specific spectral portion of the optical signal S1 is transmitted by the given TFF while the rest is reflected back to the mirror 220. That is, each filter 224 of the filter stack 222 is configured to reflect signals except for those in a specific wavelength range. In this manner, specific spectral portions or wavelength ranges of optical signals can be coupled to specific locations on the photonic die 214, such as to grating couplers 230 each tuned to a specific wavelength. The lens array 226 includes a plurality lenses that focus their respective wavelength optical signals onto the photonic die 214, e.g., to respective grating couplers 230.

The plurality of filters 224 of the filter stack 222 are arranged along a propagation direction PD (a direction extending along the longitudinal direction Z in FIG. 2). Each one of the filters 224 has a Thin-Film Filter (TFF) supported by a substrate, e.g., a glass substrate. In this example embodiment, the filters 224 include a first filter 224A, a second filter 224B, a third filter 224C, and a fourth filter 224D. The first filter 224A has a first TFF 232A supported by a first substrate 234A. The second filter 224B has a second TFF 232B supported by a second substrate 234B. The third filter 224C has a third TFF 232C supported by a third substrate 234C. The fourth filter 224D has a fourth TFF 232D supported by a fourth substrate 234D. Each one of the first, second, third, and fourth filters 224A, 224B, 224C, 224D can be associated with a different wavelength band. For instance, the first, second, third, and fourth filters 224A, 224B, 224C, 224D can be associated with bands 1270, 1290, 1310, and 1330 nm, respectively. Moreover, each filter 224 can be wide enough to accommodate multiple channels (or multiple parallel optical signals), e.g., parallel Tx and Rx channels, five Rx channels and one Tx channel, two Rx channels and two Tx channels, etc.

Each filter 224 is coupled with the lens array 226. As shown in FIG. 2, the lower end of each filter 224 is coupled with the lens array 226, e.g., by epoxy 236. The lens array 226 is in turn coupled with the photonic die 214, e.g., by epoxy 238. The filters 224 are also coupled with the filter block 216. As illustrated in FIG. 2, the upper end of each filter 224 is coupled with the lens array 226. Particularly, the filters 224 are arranged side-by-side along the propagation direction PD (or stacked) so that the TFF of every other filter connects to the filter block 216. Stated another way, the substrate of every other filter connects to the filter block 216. For instance, for the depicted embodiment of FIG. 2, the first TFF 232A of the first filter 224A and the third TFF 232C of the third filter 224C are connected to the filter block 216, while the second TFF 232B of the second filter 224B, which is positioned between the first and third filters 224A, 224C, is not connected to the filter block 216. Rather, the second substrate 234B of the second filter 224B is connected to the filter block 216. Similarly, the fourth TFF 232D of the fourth filter 224D is not connected to the filter block 216. Rather, the fourth substrate 234D of the fourth filter 224D is connected to the filter block 216.

Accordingly, in this example embodiment, the TFF of each odd filter (e.g., the first filter 224A and the third filter 224C) is connected to the filter block 216 while the TFF of each even filter (e.g., the second filter 224B and the fourth filter 224D) is not connected to the filter block 216. Rather, the substrate of each even filter is connected to the filter block 216. In this regard, the filters 224 are arranged so that each filter 224 is flipped vertically with respect to any filter positioned adjacent thereto.

In alternative embodiments, the TFF of each even filter (e.g., the second filter 224B and the fourth filter 224D) is connected to the filter block 216 while the TFF of each odd filter (e.g., the first filter 224A and the third filter 224C) is not connected to the filter block 216. In such alternative embodiments, the substrate of each odd filter can be connected to the filter block 216.

By flipping every other filter vertically as depicted in FIG. 2, the TFF of each filter 224 is vertically offset with respect to the TFF of any filter positioned adjacent thereto. For instance, as shown in FIG. 2, the first TFF 232A of the first filter 224A is vertically offset, or vertically spaced, from the second TFF of the second filter 224B, which is adjacent to the first filter 224A. The second TFF 232B of the second filter 224B is vertically offset from the first TFF 232A of the first filter 224A and the third TFF 232C of the third filter 224C. The third TFF 232C of the third filter 224C is vertically offset from the second TFF 232B of the second filter 224B and the fourth TFF 232D of the fourth filter 224D. Consequently, the fourth TFF 232D of the fourth filter 224D is vertically offset from the third TFF 232C of the third filter 224C.

As a result of flipping every other filter 224, spectral beams S1A, S1B, S1C, S1D traversing between the filters 224 and the photonic die 214 produce distinct alternating pitches, including a first pitch Δ_{Z1} (a first longitudinal distance) and a second pitch Δ_{Z2} (a second longitudinal distance). The first pitch Δ_{Z1} and second pitch Δ_{Z2} are different from one another and alternate with one another along the propagation direction PD, which in this instance extends along the longitudinal direction Z. The pitches are different due to the different thicknesses of glass that the optical signal S1 traverses through prior to passing through a given TFF. For instance, the optical signal S1 travels vertically from the mirror 220 through a thickness t1 of the filter block 216 before reaching the first TFF, and later in the sequence, vertically from the mirror 220 through the thickness t1 of the filter block 216 before reaching the third TFF. In contrast, the optical signal S1 travels vertically from the mirror 220 through a thickness t1 of the filter block 216 and a thickness t2 of the substrates before reaching the second TFF (or through a total thickness of t1+t2), and later in the sequence, vertically from the mirror 220 through the thickness t1 of the filter block 216 and the thickness t2 of the substrates before reaching the fourth TFF (or through a total thickness of t1+t2).

To compensate for the non-uniform pitches, the grating couplers 230 can be arranged on the photonic die 214 to match the alternating distinct pitches. For instance, a first grating coupler 230A and a second grating coupler 230B can be spaced a longitudinal distance (e.g., from center to center of the couplers) that corresponds with the first pitch Δ_{Z1}. The second grating coupler 230B and a third grating coupler 230C can be spaced a longitudinal distance (e.g., from center to center of the couplers) that corresponds with the second pitch Δ_{Z2}. The third grating coupler 230C and a fourth grating coupler 230D can be spaced a longitudinal distance (e.g., from center to center of the couplers) that corresponds with the first pitch Δ_{Z1}.

Further, by flipping every other filter vertically as depicted in FIG. 2, the filters 224 are arranged so that adjacent filters have radius of curvature with opposite signs, and consequently, induce opposite warpage. Hence, the filter stack 222 is an “alternating” filter stack. Specifically, the filters 224 are arranged in an alternating fashion so that the optical signal S1 is incident to alternating concave and convex TFFs. In this way, the filters 224 are arranged so that, for adjacent filters, a radius of curvature of the TFF of a first filter of the adjacent filters has an opposite sign with respect to a radius of curvature of the TFF of a second filter of the adjacent filters. Accordingly, the angle error of the reflection of odd filters become neutralized by their respective next nearest neighbor, even filters. As a result, the progressive increase of angle errors found in conventional MDMs is prevented or mitigated.

By way of example, the first filter 224A and the second filter 224B can form a first adjacent pair of filters. The first TFF 232A of the first filter 224A has a convex shape (with respect to an incoming beam undergoing demultiplexing) and thus has a positive radius of curvature. The convex shape of the first TFF 232A is shown in (a) of FIG. 3B. In contrast, the second TFF 232B of the second filter 224B has a concave shape (with respect to an incoming beam undergoing demultiplexing) and thus has a negative radius of curvature. The concave shape of the second TFF 232B is shown in (b) of FIG. 3B. Accordingly, for the first adjacent pair of filters, the radius of curvature of the first TFF 232A has an opposite sign with respect to the radius of curvature of the second TFF 232B. Further, the second filter 224B and the third filter 224C can form a second adjacent pair of filters. As noted above, the second TFF 232B of the second filter 224B has a concave shape (with respect to an incoming beam undergoing demultiplexing) and thus has a negative radius of curvature. In contrast, the third TFF 232C of the third filter 224C has a convex shape (with respect to an incoming beam undergoing demultiplexing) and thus has a positive radius of curvature. The convex shape of the third TFF 232C is shown in (c) of FIG. 3B. Thus, for the second adjacent pair of filters, the radius of curvature of the second TFF 232B has an opposite sign with respect to the radius of curvature of the third TFF 232C. In addition, the third filter 224C and the fourth filter 224D can form a third adjacent pair of filters. As noted above, the third TFF 232C of the third filter 224C has a convex shape (with respect to an incoming beam undergoing demultiplexing) and thus can have a positive radius of curvature. In contrast, the fourth TFF 232D of the fourth filter 224D has a concave shape (with respect to an incoming beam undergoing demultiplexing) and thus has a negative radius of curvature. The concave shape of the fourth TFF 232D is shown in (d) of FIG. 3B. Accordingly, for the third adjacent pair of filters, the radius of curvature of the third TFF 232C has an opposite sign with respect to the radius of curvature of the fourth TFF 232D. It will be appreciated that the convex and concave shapes of the TFFs noted are reversed with respect to an incoming beam undergoing multiplexing.

Due to the unique alternating arrangement of the filters 224, the filters 224 are arranged so that each filter 224 induces an opposite warpage of an optical signal traversing along the propagation direction PD than an immediately preceding filter. Consequently, for the MDM 200 of FIG. 2, the second filter 224B induces an opposite warpage of an optical signal traversing along the propagation direction PD than the first filter 224A, the third filter 224C induces an opposite warpage of the optical signal traversing along the propagation direction PD than the second filter 224B, and the fourth filter 224D induces an opposite warpage of the optical signal traversing along the propagation direction PD than the third filter 224C.

By way of example and with reference to FIGS. 3A and 3B, two channels or optical signals are depicted traversing along the propagation direction PD, including a first optical signal S1 and a second optical signal S2 (both of which are undergoing demultiplexing). As shown in (a) of FIG. 3A and (a) of FIG. 3B, when the first and second optical signals S1, S2 reflect off of the convex surface of the first TFF 232A (except for the spectral portions of the signals S1, S2 allowed to pass through the first TFF 232A), they both reflect vertically upward and laterally outward with respect to an optical axis OA1 of the first TFF 232A. Both signals S1, S2 reflect off of the first TFF 232A by a first angle error θ₁ (measured with respect to respective vertical lines that are aligned laterally with the incident first and second optical signals S1, S2 in this instance). After reflecting off of the first TFF 232A, the first and second optical signals S1, S2 traverse vertically upward toward the mirror 220 (FIG. 2). The first and second signals S1, 2S reflect off of the mirror 220 (FIG. 2) and traverse vertically downward toward the second TFF 232B.

As depicted in (b) of FIG. 3A and (b) of FIG. 3B, when the first and second optical signals S1, S2 reflect off of the concave surface of the second TFF 232B (except for the spectral portions of the signals S1, S2 allowed to pass through the second TFF 232B), they both reflect vertically upward and laterally inward with respect to the optical axis OA2 of the second TFF 232B. Both the first and second optical signals S1, S2 reflect off the second TFF 232B by a second angle error −θ₂ (measured with respect to respective vertical lines). When reflecting off the second TFF 232B, the first and second signals S1, S2 are slightly out of alignment with their respective ideal or desired positions, which are represented by the crosshairs. Particularly, the first and second optical signals S1, S2 reflect off the second TFF 232B from positions that are laterally outward of their desired positions.

After reflecting off of the second TFF 232B, the first and second optical signals S1, S2 reflect off the mirror 220 (FIG. 2) and traverse toward the third TFF 232C. Notably, the second angle error −θ₂ induced by the second TFF 232B has an opposite sign (and can have a same magnitude) as the first angle error θ₁ induced by the first TFF 232A. In this regard, the warpage-induced error caused by the first TFF 232A is corrected or at least compensated for by the warpage-induced error caused by the second TFF. As a result, when the first and second signals S1, S2 reach the third TFF 232C, the first and second signals S1, S2 are corrected to their respective ideal or desired positions as shown in (c) of FIG. 3A and (c) of FIG. 3B, wherein the signals S1, S1 become realigned with their respective ideal or desired positions represented by the crosshairs. Warpage-induced errors can be corrected in this manner by subsequent filters.

As depicted in (c) of FIG. 3A and (c) of FIG. 3B, when the first and second optical signals S1, S2 reflect off of the convex surface of the third TFF 232C (except for the spectral portions of the signals S1, S2 allowed to pass through the third TFF 232C), they both reflect vertically upward and laterally outward with respect to the optical axis OA3 of the third TFF 232C (similar to how the first TFF 232A reflects the first and second signals S1, S2). Both signals S1, S2 reflect off the third TFF 232C by a third angle error θ₃ (measured with respect to respective vertical lines). When reflecting off the third TFF 232C, the first and second signals S1, S2 are aligned with their respective ideal or desired positions, as noted above. So, effectively, the angle and position errors are “reset” at the third TFF 232C. After reflecting off of the third TFF 232C, the first and second optical signals S1, S2 traverse vertically upward toward the mirror 220 (FIG. 2). The first and second signals S1, 2S reflect off of the mirror 220 (FIG. 2) and traverse vertically downward toward the fourth TFF 232D.

The remaining spectral portions of the optical signals S1, S2 can be allowed to pass through the fourth TFF 232D (or can be dispersed elsewhere after reflecting off of the fourth TFF 232D). When passing through the fourth TFF 232D, the first and second signals S1, S2 are slightly out of alignment with their respective ideal or desired positions, which are represented by the crosshairs. Particularly, the first and second signals S1, S2 pass through the fourth TFF 232D from positions that are laterally outward of their desired positions. Although there is some angle and/or positional error at the fourth TFF 232D, such errors can be greatly mitigated with respect to conventional MDM systems.

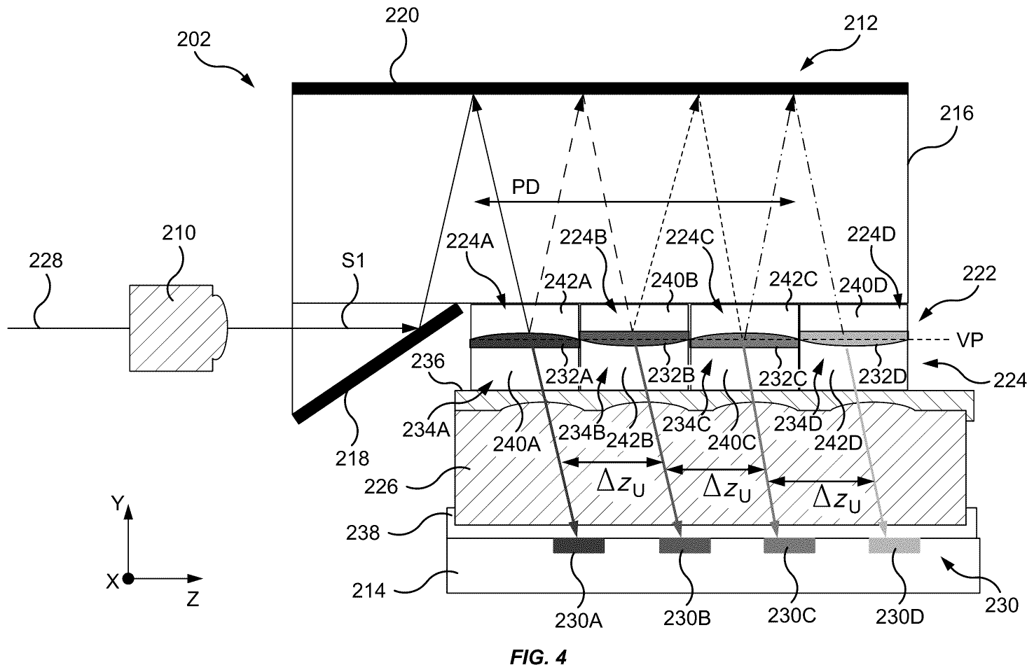

FIG. 4 is a schematic side view of an MDM 202 with an alternating filter stack in accordance with another example embodiment of the disclosure. The MDM 202 of FIG. 4 is configured in a similar manner as the MDM 200 of FIG. 2, except as provided below. Similar reference numerals will be used for like structures.

For the depicted embodiment of FIG. 4, the TFFs of the plurality of filters 224 are vertically aligned with one another, e.g., along a vertical plane VP. That is, the TFFs are arranged at a same height along the vertical direction Y. The TFF of each filter 224 is vertically sandwiched between a base and a cap, which collectively form the substrate that supports a given TFF. A TFF can be deposited on a base and the cap can then be coupled to the TFF, for example.

As illustrated in FIG. 4, for the first filter 224A, the first TFF 232A is vertically sandwiched between a first base 240A and a first cap 242A, which collectively form the first substrate 234A. The first TFF 232A has a convex shape (with respect to an incoming beam undergoing demultiplexing) and is deposited on the first base 240A. The first cap 242A is coupled with the first TFF 232A and is connected to the filter block 216. For the second filter 224B, the second TFF 232B is vertically sandwiched between a second base 240B and a second cap 242B, which collectively form the second substrate 234B. The second TFF 232B has a concave shape (with respect to an incoming beam undergoing demultiplexing) and is deposited on the second base 240B. The second base 240B is connected to the filter block 216. The second cap 242B is coupled with the second TFF 232B at one end is coupled with the epoxy 236 at its other end. The second filter 224B is thus flipped vertically with respect to the first filter 224A, but as noted, the first TFF 232A and the second TFF 232B are arranged at a same height.

As further shown in FIG. 4, for the third filter 224C, the third TFF 232C is vertically sandwiched between a third base 240C and a third cap 242C, which collectively form the third substrate 234C. The third TFF 232C has a convex shape (with respect to an incoming beam undergoing demultiplexing) and is deposited on the third base 240C. The third cap 242C is coupled with the third TFF 232C and is connected to the filter block 216. For the fourth filter 224D, the fourth TFF 232D is vertically sandwiched between a fourth base 240D and a fourth cap 242D, which collectively form the fourth substrate 234D. The fourth TFF 232D has a concave shape (with respect to an incoming beam undergoing demultiplexing) and is deposited on the fourth base 240D. The fourth base 240D is connected to the filter block 216. The fourth cap 242D is coupled with the fourth TFF 232D at one end is coupled with the epoxy 236 at its other end. The fourth filter 224D is thus flipped vertically with respect to the third filter 224C, but as noted, the third TFF 232C and the fourth TFF 232D are arranged at a same height. Consequently, the first, second, third, and fourth TFFs 232A, 232B, 232C, 232D are arranged at the same height.

The unique arrangement of the filter stack 222 in the embodiment of FIG. 4 advantageously enables spectral beams S1A, S1B, S1C, S1D traversing between the filters 224 and the photonic die 214 to produce a uniform pitch, e.g., pitch Δ_{ZU}, namely because due to thicknesses of glass that the optical signal S1 traverses through being the same prior to passing through a given TFF. In this regard, the grating couplers 230 can have uniform spacing, e.g., along the longitudinal direction Z. Accordingly, the grating coupler 230 can be spaced a longitudinal distance (e.g., from center to center of the couplers) that corresponds with the uniform pitch Δ_{ZU}.

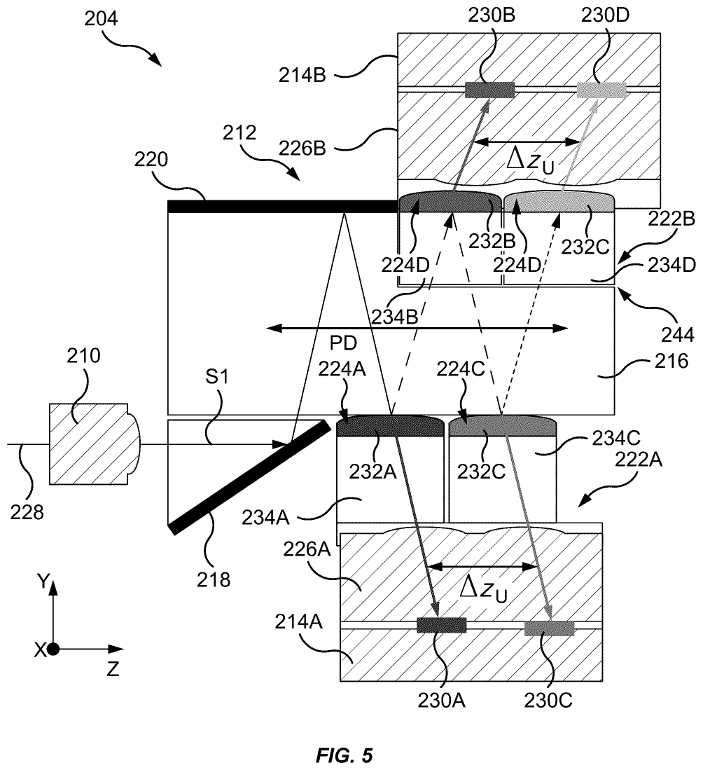

FIG. 5 is a schematic side view of an MDM 204 with an alternating filter stack in accordance with yet another example embodiment of the disclosure. The MDM 204 of FIG. 5 is configured in a similar manner as the MDM 200 of FIG. 2, except as provided below. Similar reference numerals will be used for like structures.

For the depicted embodiment of FIG. 5, the filters 224 are arranged along the propagation direction PD in at least a first stack 222A and a second stack 222B. The first stack 222A is spaced from the second stack 222B by the filter block 216. In this regard, the first stack 222A is spaced from the second stack 222B along the vertical direction Y. The MDM 204 also includes a first lens array 226A and a first photonic die 214A associated with the first stack 222A and a second lens array 226B and a second photonic die 214B associated with the second stack 222B.

The first stack 222A includes at least two filters stacked adjacent to one another, e.g., along the propagation direction PD, and the TFFs of both filters have a radius of curvature. The radius of curvature of the TFFs of the first stack 222A have a same sign. Particularly, for the depicted embodiment of FIG. 5, the first filter 224A and the third filter 224C are arranged in the first stack 222A. The first TFF 232A of the first filter 224A and the third TFF 232C of the third filter 224C both have a convex shape (with respect to an incoming beam undergoing demultiplexing). In this regard, each filter of the first stack 222A that is arranged side-by-side along the propagation direction PD induces a same warpage. The first and third TFFs 232A, 232C are connected to a bottom edge of the filter block 216. The first and third substrates 234A, 234C are coupled with the first lens array 226A, e.g., via epoxy.

The second stack 222B includes at least two filters stacked adjacent to one another, e.g., along the propagation direction PD. The filter block 216 defines a cutout 244 in which the filters of the second stack 222B are positioned. Particularly, for the depicted embodiment of FIG. 5, the second filter 224B and the fourth filter 224D are arranged in the second stack 222B. The second and fourth filters 224B, 224D are arranged in the cutout 244 with the second substrate 234B and the fourth substrate 234D being connected to the filter block 216. The second and fourth TFFs 232B, 232D are vertically aligned with the mirror 220, which extends lengthwise parallel to the propagation direction PD. Further, the TFFs of both filters of the second stack 222B have a radius of curvature. The radius of curvature of the TFFs of the second stack 222B have a same sign. The second TFF 232B of the second filter 224B and the fourth TFF 232D of the fourth filter 224D both have a concave shape (with respect to an incoming beam undergoing demultiplexing). In this regard, each filter of the second stack 222B that is arranged side-by-side along the propagation direction PD induces a same warpage.

Accordingly, the radius of curvature of the filters of the first stack 222A have a same sign and the radius of curvature of the filters of the second stack 222B have a same sign that is different than the same sign of the radius of curvature of the filters of the first stack 222A. Stated differently, the TFFs of the first stack 222A both have a same curvature of reflection and the TFFs of the second stack 222B have a same curvature of reflection, which is opposite the curvature of reflection of the TFFs of the first stack 222A.

Further, the first and second stacks 222A, 222B are arranged so that filters are staggered along the propagation direction PD, which extends along the longitudinal direction Z in this example embodiment. The filters are staggered in that the second filter 224B overlaps with, but is not centered with, the first filter 224A along the propagation direction PD. Similarly, the third filter 224C overlaps with, but is not centered with, the second filter 224B along the propagation direction PD. Likewise, the fourth filter 224D overlaps with, but is not centered with, the third filter 224C along the propagation direction PD.

In this way, for a demultiplexing mode, the optical signal S1 collimated at the lens 210 reflects off of the prism 218 and traverses toward the mirror 220. The optical signal S1 then reflects off of the mirror 220 and traverses in an alternating manner between the TFFs of the first stack 222A and the TFFs of the second stack 222B, with each TFF allowing a specific spectral portion of the optical signal S1 to pass therethrough, e.g., to the respective grating couplers disposed on the respective first and second photonic dies 214A, 214B. More specifically, after reflecting off of the mirror 220, the optical signal S1 traverses to the first TFF 232A of the first filter 224A, which is arranged in the first stack 222A. The optical signal S1 is reflected by the convex surface of the first TFF 232A (except for a first spectral portion of the optical signal S1) toward the second TFF 232B of the second filter 224B, which is arranged in the second stack 222B. The optical signal S1 is reflected by the concave surface of the second TFF 232B (except for a second spectral portion of the optical signal S1) toward the third TFF 232C of the third filter 224C, which is arranged in the first stack 222A. Then, the optical signal S1 is reflected by the convex surface of the third TFF 232C (except for a third spectral portion of the optical signal S1) toward the fourth TFF 232D of the fourth filter 224D, which is arranged in the second stack 222B. The fourth TFF 232D can allow a fourth spectral portion of the optical signal S1 to pass therethrough. Accordingly, for the depicted embodiment of FIG. 5, the filters 224A, 224B, 224C, 224D are arranged so that each filter induces an opposite warpage of an optical signal traversing along the propagation direction PD than an immediately preceding filter.

The MDM 204 of FIG. 5 can provide certain advantages, benefits, and/or technical effects. For instance, with the alternating split-stack arrangement of the MDM 204 of FIG. 5, the longitudinal length (or length along the longitudinal direction Z) can be made shorter compared to MDMs that have each filter arranged in a single stack. Further, the MDM 204 of FIG. 5 allows for uniform pitch and allows for the filters to be stacked in a same mounting orientation, e.g., right side up with the TFF of each filter vertically above its associated supporting substrate, which can simplify fabrication of the MDM 204.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. A multiplexer and demultiplexer (MDM), comprising:
a plurality of filters arranged along a propagation direction of an optical signal, each one of the plurality of filters having a thin-film filter (TFF) supported by a substrate, and
wherein the plurality of filters are arranged so that each filter of the plurality of filters induces an opposite warpage of the optical signal traversing along the propagation direction than an immediately preceding filter of the plurality of filters.

2. The MDM of claim 1, wherein the plurality of filters are arranged so that the TFFs have alternating concave and convex curvatures relative to the propagation direction.

3. The MDM of claim 1, wherein the plurality of filters are arranged so that adjacent filters of the plurality of filters have opposite radius of curvature.

4. The MDM of claim 1, further comprising:
a filter block, and
wherein the plurality of filters are arranged along the propagation direction so that the TFF of every other filter of the plurality of filters connects to the filter block.

5. The MDM of claim 1, further comprising:
a filter block, and
wherein the plurality of filters are arranged along the propagation direction so that the substrate of every other filter of the plurality of filters connects to the filter block.

6. The MDM of claim 1, wherein the plurality of filters are arranged so that each one of the plurality of filters is flipped vertically with respect to any filter of the plurality of filters positioned adjacent thereto.

7. The MDM of claim 1, wherein spectral beams that pass through respective ones of the plurality of filters produce a first pitch and a second pitch, the first pitch and second pitch are different from one another and alternate with one another along the propagation direction.

8. The MDM of claim 1, wherein the plurality of filters are arranged so that the TFFs of adjacent filters of the plurality of filters are vertically offset from one another.

9. The MDM of claim 1, wherein the plurality of filters are arranged so that the TFFs of the plurality of filters are vertically aligned with one another.

10. The MDM of claim 9, wherein spectral beams that pass through respective ones of the plurality of filters produce a uniform pitch.

11. The MDM of claim 1, wherein the substrate of each filter of the plurality of filters has a base and a cap, and wherein each filter of the plurality of filters is arranged so that, for a given filter of the plurality of filters, the TFF is vertically sandwiched between the base and the cap of the given filter.

12. The MDM of claim 1, wherein the plurality of filters are arranged along the propagation direction in at least a first stack and a second stack, the first stack is spaced from the second stack by a filter block.

13. The MDM of claim 12, wherein:
the first stack includes at least two filters of the plurality of filters stacked adjacent to one another,
the second stack includes at least two filters of the plurality of filters stacked adjacent to one another, and
wherein the TFFs of the at least two filters of the first stack each have a positive radius of curvature and the TFFs of the at least two filters of the second stack each have a negative radius of curvature.

14. The MDM of claim 12, wherein:
the first stack includes at least two filters of the plurality of filters stacked adjacent to one another,
the second stack includes at least two filters of the plurality of filters stacked adjacent to one another, and
wherein the at least two filters of the first stack and the at least two filters of the second stack are staggered along the propagation direction.

15. The MDM of claim 12, wherein:
the first stack includes at least two filters of the plurality of filters stacked adjacent to one another,
the second stack includes at least two filters of the plurality of filters stacked adjacent to one another, and
wherein the optical signal traversing along the propagation direction traverses in an alternating manner between one of the at least two filters of the first stack and one of the at least two filters of the second stack.

16. The MDM of claim 12, wherein:
the first stack includes at least one filter of the plurality of filters,
the second stack includes at least one filter of the plurality of filters, and
wherein the MDM further comprises:
a first lens array;
a first photonic die coupled with the first lens array, and wherein the at least one filter of the first stack is coupled with the first lens array;
a second lens array; and
a second photonic die coupled with the second lens array, and wherein the at least one filter of the second stack is coupled with the second lens array.

17. The MDM of claim 12, wherein:
the first stack includes at least one filter of the plurality of filters,
the second stack includes at least one filter of the plurality of filters, and
wherein the filter block defines a cutout in which the at least one filter of the second stack is positioned, and wherein the TFF of each one of the at least one filter of the second stack is vertically aligned with a mirror that extends lengthwise parallel to the propagation direction.

18. The MDM of claim 12, wherein:
the first stack includes at least two filters of the plurality of filters stacked adjacent to one another,
the second stack includes at least two filters of the plurality of filters stacked adjacent to one another, and
wherein the at least two filters of the first stack and the at least two filters of the second stack have a same mounting orientation.

19. A multiplexer and demultiplexer (MDM), comprising:
a plurality of filters arranged along a propagation direction, each one of the plurality of filters having a thin-film filter (TFF) supported by a substrate, and
wherein the plurality of filters are arranged so that the TFFs have alternating concave and convex curvatures along the propagation direction.

20. A multiplexer and demultiplexer (MDM), comprising:
a filter block; and
a plurality of filters arranged along a propagation direction of an optical signal in a first stack and a second stack spaced from the first stack by the filter block, each one of the plurality of filters has a thin-film filter (TFF) supported by a substrate, and
wherein the optical signal traverses between the first stack and the second stack in an alternating manner, and
wherein the plurality of filters are arranged so that a second filter of the plurality of filters arranged in the second stack induces an opposite warpage of an optical signal traversing along the propagation direction than a first filter of the plurality of filters arranged in the first stack.
